(19) United States
(12) Patent Application Publication
(10) Pub. No.: US 2026/0080161 A1
(43) Pub. Date: Mar. 19, 2026

(54) Computer System, Computer-Implemented Method, and Computer Readable Media for Handling Incomplete Inputs to Large Language Models (LLMs)

(71) Applicant: Shopify Inc., Ottawa (CA)

(72) Inventor: Ates GÖRAL, Toronto (CA)

(73) Assignee: Shopify Inc., Ottawa (CA)

(21) Appl. No.: 18/923,926

(22) Filed: Oct. 23, 2024

Related U.S. Application Data
(60) Provisional application No. 63/696,049, filed on Sep. 18, 2024.

(51) Int. Cl. G06F 40/20; H04L 51/216

(52) U.S. Cl. CPC G06F 40/20; H04L 51/216

(57) ABSTRACT

A system and method are provided for handling incomplete inputs to large language models (LLMs). The method includes, responsive to detecting an incomplete input in a messaging conversation, buffering the incomplete input prior to having an LLM respond to a prompt associated with the incomplete input.

### CROSS-REFERENCE TO RELATED APPLICATION(S)

This application claims priority to U.S. Provisional Application No. 63/696,049 filed on Sep. 18, 2024, the entire contents of which are incorporated herein by reference.

### TECHNICAL FIELD

The following relates generally to handling inputs to LLMs and, in particular, to handling incomplete inputs to LLMs, for example, by buffering incomplete inputs prior to having the LLM respond to prompts.

### BACKGROUND

In typical electronic messaging conversations between entities, each entity enters or generates a string of text or provides a verbal message and sends that to the other entity. Whether both entities are human or at least one entity is artificial (e.g., chatbot using or not using an LLM), the rigid one-by-one conversational structure may not entirely mimic natural human interactions, since one entity may pause or otherwise provide an incomplete thought in a message that has been composed. Similarly, an entity may break up long phrases of text, verbal instructions, or requests into multiple entries, each of which may provide an incomplete input.

### BRIEF DESCRIPTION OF THE DRAWINGS

Embodiments will now be described with reference to the appended drawings wherein:

FIG. 1 is an example of a computing environment in which inputs are evaluated prior to prompting an LLM.

FIG. 2 is an example of a configuration for evaluating and buffering inputs using a prompt completion analysis.

FIG. 3 is another example of a configuration for evaluating and buffering inputs using a prompt completion analysis.

FIG. 4 is another example of a configuration for evaluating and buffering inputs using a prompt completion analysis.

FIG. 5 is an example of a configuration for verifying an input evaluated at a client device by a server device.

FIG. 6 illustrates a module for performing a prompt completion analysis in evaluating and buffering inputs.

FIG. 7 is an example of a configuration for evaluating and buffering inputs using an LLM trained to perform such evaluating.

FIG. 8 is an example of a computing device operable to communicate in the computing environment.

FIG. 9 is a flow chart illustrating example operations for buffering incomplete inputs prior to having the LLM respond to prompts.

FIG. 10 illustrates an example of an electronic messaging conversation user interface (UI).

FIG. 11 is a flow chart illustrating example operations for buffering incomplete inputs prior to having an LLM respond to prompts, using the configuration shown in FIG. 2.

FIG. 12 is a flow chart illustrating example operations for buffering incomplete inputs prior to having an LLM respond to prompts, using the configuration shown in FIG. 3.

FIG. 13 is a flow chart illustrating example operations for buffering incomplete inputs prior to having an LLM respond to prompts, using the configuration shown in FIG. 5.

FIG. 14 is a flow chart illustrating example operations for buffering incomplete inputs prior to having an LLM respond to prompts, using the configuration shown in FIG. 7.

FIG. 15 illustrates waiting and progress objects displayed in a messaging conversation UI.

FIG. 16 illustrates a chatbot assistant waiting message displayed in a messaging conversation UI.

FIG. 17 illustrates a timer object displayed in a messaging conversation UI.

FIG. 18 illustrates an expired timer object and follow-up message displayed in a messaging conversation UI.

FIG. 19 is a block diagram of a simplified convolutional neural network, which may be used in examples of the present disclosure.

FIG. 20 is a block diagram of a simplified transformer neural network, which may be used in examples of the present disclosure.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

The above-noted issues with incomplete or partial inputs to an LLM may be exacerbated when messaging within an electronic messaging conversation (hereinafter also referred to as a “messaging conversation” for brevity), e.g., with a chatbot that utilizes an LLM, since LLMs are normally configured to process the entirety of the input they are provided on a first come, first served basis. As such, an incomplete or partial input may generate an incomplete or incorrect response. Moreover, the LLM may be unable to process the input without receiving additional information, such as the complete thought or a complete instruction from the other entity.

It is recognized that there are times when a user does not input enough information for an LLM to respond as desired, as intended, or at all and, as such, the LLM (or chatbot) should wait for more information. On the other hand, current chatbot tools may lack a way to indicate to the user that the LLM is waiting for, or at least would benefit from, additional information. Similarly, mechanisms are found to be lacking to buffer or otherwise control when partial or incomplete messages are provided to the LLM, which may lead to inefficient use of the LLM in a conversational messaging exchange, e.g., with a chatbot.

To address these challenges, the following describes a prompt evaluation and buffering system that is configured to coordinate between the front end and back end of the electronic messaging system to signal to one another that a partial or incomplete request has been detected and update the front-end UI and/or buffer inputs to the LLM accordingly.

The present evaluation and buffering system may be configured or tuned to cache, temporarily store, wait for, or otherwise buffer varying amounts of information, according to varying metrics, or by utilizing various types of evaluator mechanisms. The evaluator mechanisms may include, without limitation, additional lighter weight LLMs, natural language processing (NLP) tools, small language models, look-up-tables, etc. The evaluators may include, for example, smaller, faster models hosted locally on the client side or on the server side in front or one step ahead of a primary LLM used as a chatbot to respond to queries.

Responsive to detecting an incomplete message or pause in the conversation (e.g., after “So, um”, and/or “what I really want to do”), the UI may be updated to indicate that the chatbot and LLM are waiting for more information. For example, a “silence” or “waiting” message or object may be displayed, an animation or icon object may be inserted, or some other cue may be provided. For example, in a voice conversation, a chime or other auditory message such as an utterance like “mhmmm?” may be played to acknowledge the user's input thus far and to encourage them to continue. Such an utterance may, additionally or alternatively, be displayed using a message.

To avoid a conversation that encounters a pause or incomplete message from “hanging” indefinitely, a timer may be used to trigger a message to be displayed or played to elicit a response. Moreover, the timer may be used to end a conversation with the chatbot after an extended delay.

As further illustrated herein, the evaluation and buffering system may be configured in various ways to enable the front end and back end components to coordinate the above detection and display mechanisms.

In one aspect, there is provided a computer-implemented method comprising, responsive to detecting an incomplete input in a messaging conversation, buffering the incomplete input prior to having an LLM respond to a prompt associated with the incomplete input.

In certain example embodiments, the incomplete input is detected at a client device.

In certain example embodiments, the incomplete input is buffered at the client device.

In certain example embodiments, the incomplete input is detected using an NLP tool applied to the incomplete input.

In certain example embodiments, the incomplete input is detected using another LLM applied to the incomplete input.

In certain example embodiments, the incomplete input is detected using a small language model.

In certain example embodiments, the method further includes receiving the incomplete input as detected at the client device, and confirming that the input is incomplete at a server device prior to the buffering.

In certain example embodiments, the confirming is performed using another LLM.

In certain example embodiments, the incomplete input is detected at a server device, the server device being in communication with the LLM.

In certain example embodiments, the incomplete input is buffered at the server device.

In certain example embodiments, the incomplete input is buffered at either a client device or a server device.

In certain example embodiments, the incomplete input is detected by the LLM, the buffering comprising receiving additional information prior to sending a response to a client device.

In certain example embodiments, the buffering comprises retrieving the incomplete input from a conversation history.

In certain example embodiments, the buffering comprises receiving at least one additional input.

In certain example embodiments, a UI associated with the messaging conversation displays at least two consecutive messages from an entity providing the incomplete input prior to a response message based on the prompt.

In certain example embodiments, the method further includes having an interim object displayed in the messaging conversation during the buffering.

In certain example embodiments, the interim object comprises a message indicative of a pause or silence in a conversation following a message comprising the incomplete input.

In certain example embodiments, the interim object comprises an animation or icon indicative of the buffering.

In certain example embodiments, the incomplete input comprises a voice message.

In certain example embodiments, the incomplete input comprises text composed in a message.

In certain example embodiments, the method further includes executing an action in the messaging conversation responsive to detecting expiration of a timer.

In certain example embodiments, the action comprises providing a response message in the messaging conversation.

In certain example embodiments, the action comprises terminating the messaging conversation.

In certain example embodiments, the buffering comprises accumulating at least one additional incomplete input.

In another aspect, there is provided a computer system comprising at least one processor and at least one memory, the at least one memory comprising processor executable instructions that, when executed by the at least one processor, cause the computer system to, responsive to detecting an incomplete input in a messaging conversation, buffer the incomplete input prior to having an LLM respond to a prompt associated with the incomplete input.

In another aspect, there is provided a computer-readable medium comprising processor executable instructions that, when executed by a processor of a computer system, cause the computer system to, responsive to detecting an incomplete input in a messaging conversation, buffer the incomplete input prior to having an LLM respond to a prompt associated with the incomplete input.

It can be appreciated from example configurations illustrated herein that any number of intermediate components and/or server devices or other computing entities may be utilized to separate the roles of processing, evaluating, detecting, buffering, and completing user messages; and sending the completed user messages to the LLM to prompt the LLM to generate a response.

It can also be appreciated that “buffering” as used herein may refer to storing the partial or incomplete inputs or may refer to retrieving the incomplete inputs from a conversation history that, when combined (e.g., by the buffer or other module), may provide the completed message. That is, the buffering may not necessarily store the incomplete inputs but instead retrieve the message content directly from the conversation history or some other source to which it has access.

By implementing the active listening operations that may be performed by the evaluation and buffering system, a chatbot experience may more closely mimic a human conversation by being able to detect and react to pauses or incomplete inputs from a correspondent in the messaging conversation. In this way, rather than sending an incomplete input to the LLM to be processed, the system may wait until the input is deemed to be complete in order to avoid unnecessary messages and unnecessary calls to the LLM. This may additionally result in LLM processing speed improvements, reduced compute costs, and reduced bandwidth requirements, along with an improved user experience.

The principles discussed herein apply to both text and voice conversations. In a voice conversation, the ability to detect a pause or incomplete thought may avoid potentially annoying or distracting intermediate replies from the chatbot while the user is thinking and/or adding to their previous utterance.

### Evaluating and Buffering Inputs Prior to Prompting an LLM

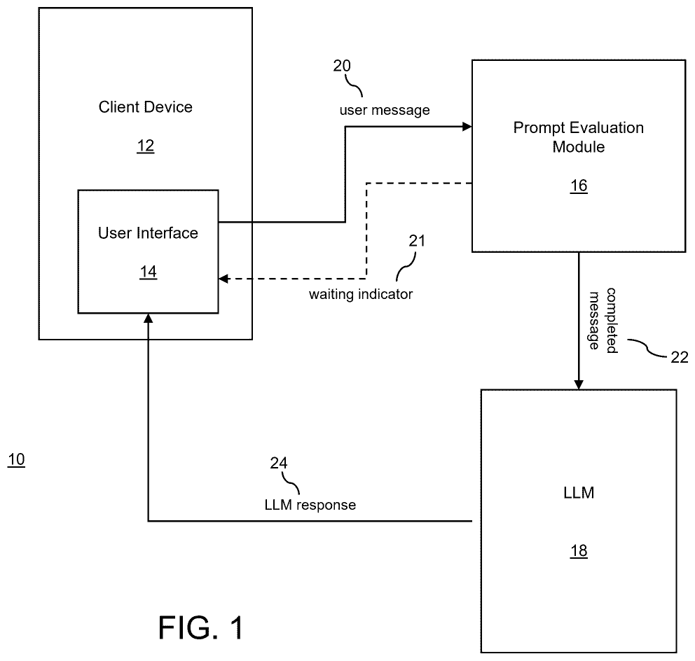

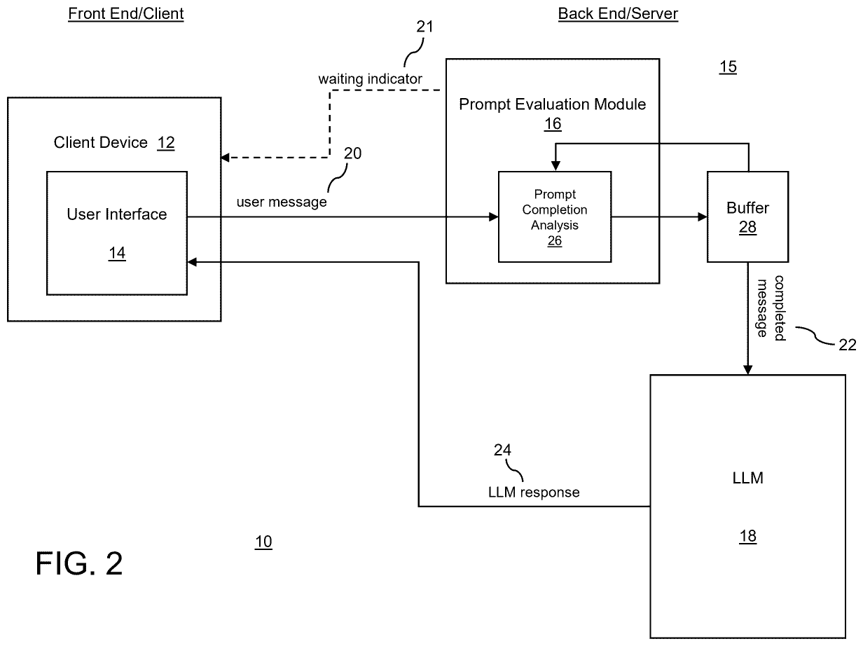

Referring now to the figures, FIG. 1 illustrates an example of a computing environment 10 in which a messaging conversation (e.g., chatbot) UI 14 is provided by or with one or more computing devices such as the illustrated client device 12. For example, the UI 14 may be running on a client device 12 such as a smartphone or tablet, which is in communication with a sever utility or application by one or more server computing devices, identified using numeral “15” in FIGS. 2-5. That is, a server-based application (not shown) may be hosted by a server computing device 15 to exchange data and information with a corresponding client application that provides the UI 14 via the client device 12. As reflected by the configuration shown in FIG. 1, however, a server device 15 may be optional in some implementations.

Such computing devices 12, 15 (or computing systems) may include, but are not limited to, a mobile phone, a personal computer, a laptop computer, a server computer, a tablet computer, a notebook computer, a hand-held computer, a personal digital assistant, a portable navigation device, a wearable device, a gaming device, an embedded device, a virtual reality device, an augmented reality device, etc.

The client device 12 and UI 14 include or are in communication with a prompt evaluation module 16. The prompt evaluation module 16 is interposed between the UI 14 and the LLM 18 to evaluate and buffer inputs such as user messages 20 prior to prompting an LLM 18 using a completed message 22 (i.e. prompt). It can be appreciated that the user messages 20 may be generated from various types of inputs, including text (e.g., a message composed in the UI 14), voice (e.g., speech-to-text input provided to the client device 12 to compose message in the UI 14), or other biometric signal that can be converted into text (e.g., gaze, EEG, gesture/sign language, etc.). It can also be appreciated that any conversion of the input may be performed on the client side or the server side and therefore the user message 20 shown in FIG. 1 may represent the input that is or is to be converted into a form suitable for processing by the prompt evaluation module 16 and/or LLM 18.

The LLM 18 is being called to generate an LLM response 24 that is returned to the UI 14, e.g., by the LLM 18 directly or via a server device 15 as discussed above. Optionally, as shown in dashed lines, a waiting indicator 21 (e.g., a message or object) may be communicated by the prompt evaluation module 16 to the UI 14 to signal to the UI 14 that the user message 20 is deemed to be incomplete. This may cause the UI 14 to display an object or message to covey this information to the user as discussed below. The waiting indicator 21 may be used as an interim reply, to generate a waiting object such as a “silence” token or other indicator or may cause the UI to wait and do nothing until enough information is provided. The indicator may take the form of a flag (e.g., [|silence|]), or some other placeholder (e.g., one or more LLM tokens). The indicator may be either in-band in the channel used for communicating the LLM responses 24 or be provided using out-of-band signaling. That is, the indicator may be returned to the front end by the prompt evaluation module 16 (e.g., responsive to detecting an incomplete input) or via an out-of-band module (not shown) that may be called by the prompt evaluation module 16 or the UI 14. For example, rather than an LLM token, other signaling may be utilized out-of-band.

The UI 14 may be hosted by, or otherwise run on, the client device 12, or may be accessed by the client device 12 over a communication network (not shown). Such communication network(s) may include a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The application providing the UI 14 may take the form of a mobile-type application (also referred to as an “app”), a desktop-type application, an embedded application in customized computing systems, or an instance or page contained and provided within a web/Internet browser, to name a few.

The LLM 18 may be provided by a separate computing device or computing system, by a separate entity or may be integrated with the application that provides the UI 14 within the same computing device or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as a client device 12 and server device 15 or a client device 12 and a remote or offsite storage or processing entity or service. That is, the computing environment 10 may be implemented using any one or more electronic devices including standalone devices and those connected to offsite storage and processing operations (e.g., via cloud-based computing storage and processing facilities).

Referring now to FIG. 2, an example is provided illustrating a configuration for the computing environment 10 in which the client device 12 communicates with a server device 15 that hosts or otherwise provides the prompt evaluation module 16. The user interface 14 in this example may utilize a communication connection provided by the client device 12 to send user messages 20 to the server device 15 to have a process, script, utility, function, tool, etc., referred to generally herein as a “prompt completion analysis” 26 applied by the prompt evaluation module 16 to the user message 20.

The prompt completion analysis 26 is used to determine whether the user message 20 may be considered a complete input or whether it is incomplete and may require additional content, context, or both. For example, a waiting indicator 21 may be returned by the prompt evaluation module 16 to the client device 12 to enable the client device 12 to have a waiting message or waiting object displayed in the UI 14. The waiting indicator 21 may be sent in-band or out-of-band, that is, may utilize the same or different channel that is being used to prompt the LLM 18.

When the prompt completion analysis 26 determines that the user message 20 is an incomplete input, that incomplete input (e.g., the message 20 or a portion thereof and/or the message 20 plus contextual information) may be held by a buffer 28. The buffer 28 may store the incomplete input or a pointer to another storage location such as a chat history maintained by a server application (e.g., using the prompt evaluation module 16). The buffer 28 operates to have the prompt completion analysis 26 performed at least one additional time, e.g., upon receipt of further user message(s) 20, after a duration of time, upon receipt of additional contextual information (in- or out-of-band), etc. For example, the prompt completion analysis 26 may be performed upon receipt of a second user message 20, which when combined with the first user message 20 provides a complete input.

In other example, the prompt completion analysis 26 may wait a period of time subsequent to receiving the user message 20 to confirm that additional information is not coming. This technique may be initiated when the prompt completion analysis 26 determines that the user message 20 may be complete but the content of the user message 20 suggests that additional information may be provided. For example, the user message 20 may include: “I would like to know how to send a gift by mail or”. In this case, the “or” at the end of the message appears to be an incomplete thought but the user had simply included it by mistake or had completed their thought without correcting the message. The prompt completion analysis 26 may apply an analytical or statistical technique to measure confidence in the completeness of an input, in which case the confidence level in this case may not be high enough. However, by waiting a certain amount of time, such as a few seconds, the confidence may increase that no additional user message 20 is coming.

The prompt evaluation module 16 and buffer 28 may therefore be interposed between the UI 14 calling the LLM 18 and the LLM 18 itself, to intercept user messages 20 to determine their completeness. The prompt completion analysis 26 and buffer 28 may provide one feedback loop and, optionally, the prompt evaluation module 16 and the client device 12 may provide another feedback loop via the waiting indicator 21 to facilitate preparation of a completed message 22 that may be used in a prompt to the LLM 18. The LLM 18 may then process the complete message 22 when prompted to generate an LLM response 24 that is returned to the UI 14. The LLM response 24 may, for example, be presented to the user in the UI 14 as a message or reply to the one or more user messages 20 used to prompt the LLM 18.

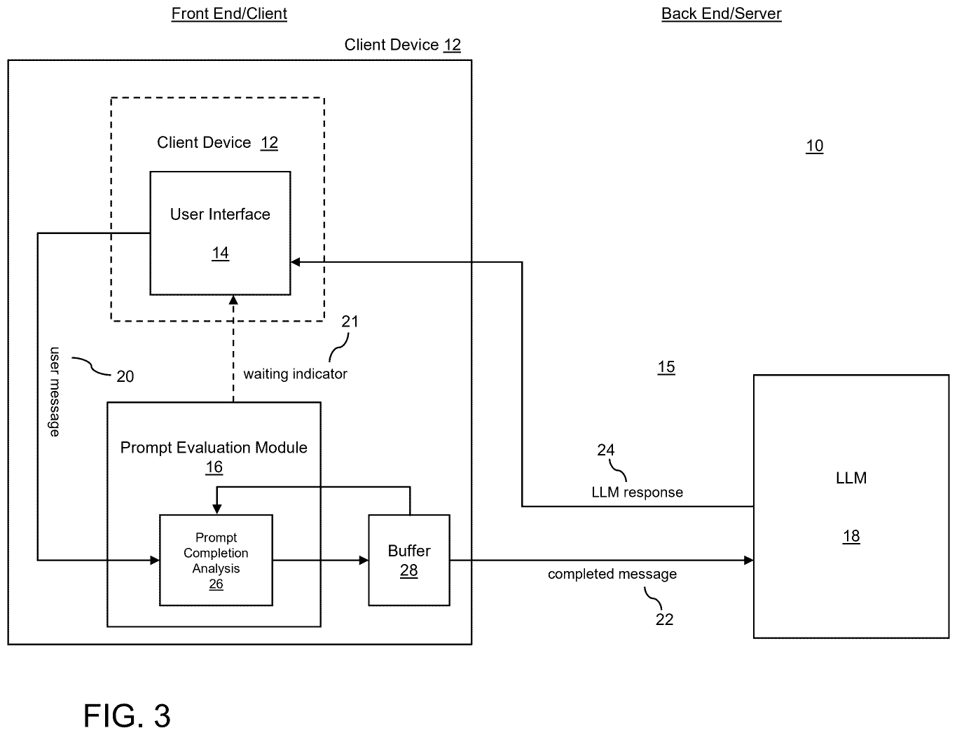

In the configuration shown in FIG. 2, the prompt evaluation module 16, the prompt completion analysis 26, and the buffer 28 are located at a server device 15 and may be performed by a server application that communicates with a client application that provides the UI 14. In another configuration, shown in FIG. 3, the prompt evaluation module 16, prompt completion analysis 26, and buffer 28 may be performed on the client side, e.g., by the client device 12 or another front end entity (e.g., as shown using dashed lines). The back end or server side shown in FIG. 3 may include one or more server devices 15 or may interface directly with the LLM 18, e.g., via an application programming interface (API) for the LLM 18. In the configuration shown in FIG. 3, the user message(s) 20 is/are buffered on the client side, e.g., at the client device 12 by a client application providing the UI 14 and waiting indicator(s) 21 may be used to signal to the user that the other correspondent (e.g., chatbot) is waiting for additional information to prompt the LLM 18. As in the configuration shown in FIG. 2, the completed message 22 may then be used to prompt the LLM 18 and obtain an LLM response 24 that is used by the UI 14 to reply to the user message(s) 20 used to create the completed message 22.

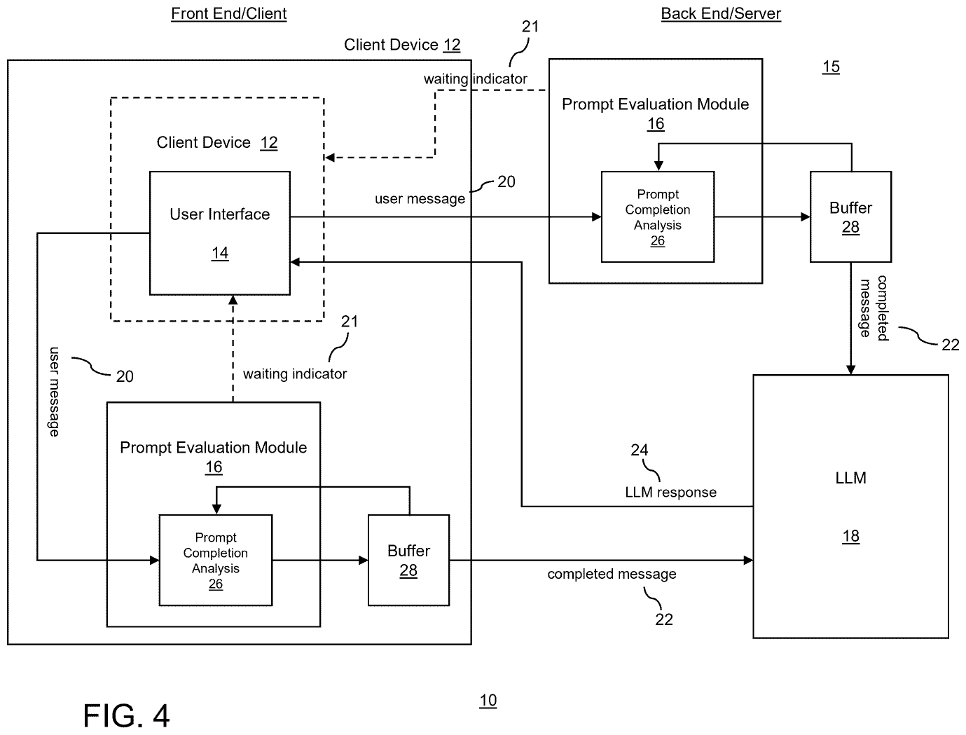

Referring now to FIG. 4, a prompt evaluation module 16 and buffer 28 may be provided at both the client side and server side such that the prompt completion analysis 26 may be performed by either or both the client 12 and the server device 15. Depending on the nature of the user message 20, the UI 14 may be configured to choose which of the client side or the server side should perform the analysis. For example, the client device 12 may use a local prompt evaluation module 16 for relatively simpler analyses and a remote (i.e., server-based) prompt evaluation module 16 for relatively more complex analyses based on availability of less or more sophisticated evaluation mechanisms, e.g., look-up-tables versus additional LLMs.

In another example, the client device 12 may use both local- and server-based prompt evaluation modules 16 in the same session, e.g., when an initial evaluation needs to be escalated to a more sophisticated mechanism provided by the server-based prompt evaluation module 16.

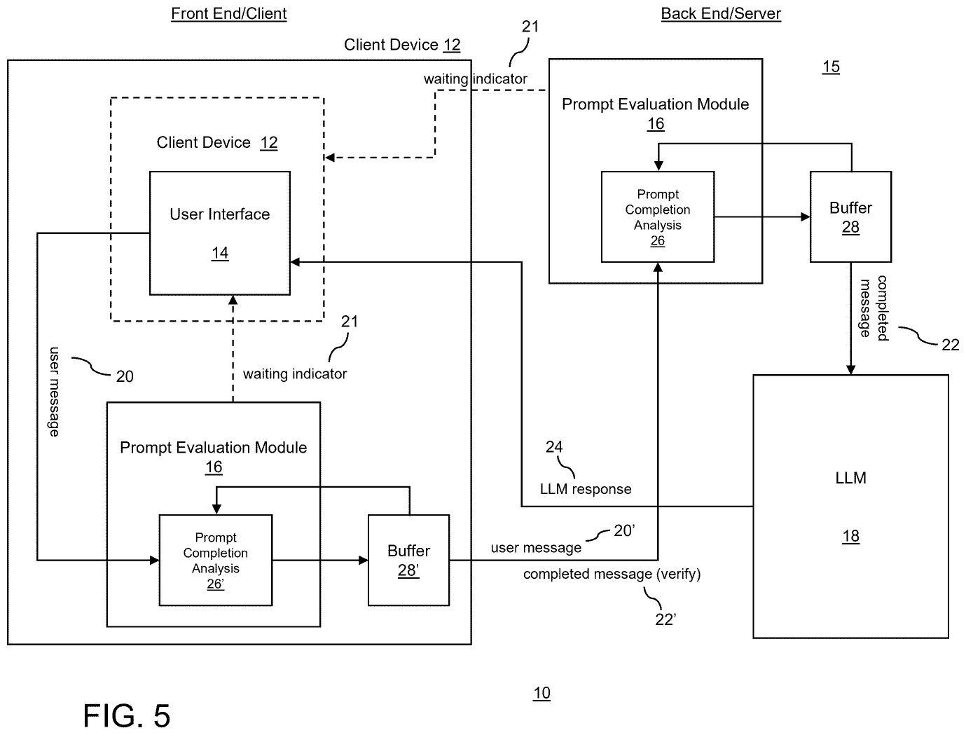

As shown in FIG. 5, the client device 12 may, additionally or alternatively, utilize a prompt evaluation module 16 at the server device 15 to verify a complete message 22′ prepared by the prompt evaluation module 16′ located at the client device 12. In this way, the client device 12 may utilize a less complex prompt completion analysis 26′ to determine if/when a user message 20 is incomplete, but have either or both the user message 20′ and the completed message 22′ verified to confirm the determination made by the local prompt completion analysis 26′. For example, an initial evaluation may be performed via the local prompt completion analysis 26′ at the client side, which is then sent to the server side prompt evaluation module 16 for verification prior to prompting the LLM 18 with the completed message 22. It can be appreciated that one or more feedback loops, using waiting indicators 21 or other messaging, may be used to signal between the prompt evaluation modules 16, 16′ the status of the respective buffers 28′, 28 and whether additional messages or context is required. In this way, the client device 12 and server device 15 may coordinate analyses on behalf of the UI 14 and to intercept incomplete inputs on behalf of the LLM 18 thus providing a more humanlike interaction with the LLM 18 as the other correspondent in the messaging conversation (via the UI 14) as well as reducing the number of calls to the LLM 18 than may waste time and resources and lead to erroneous outputs.

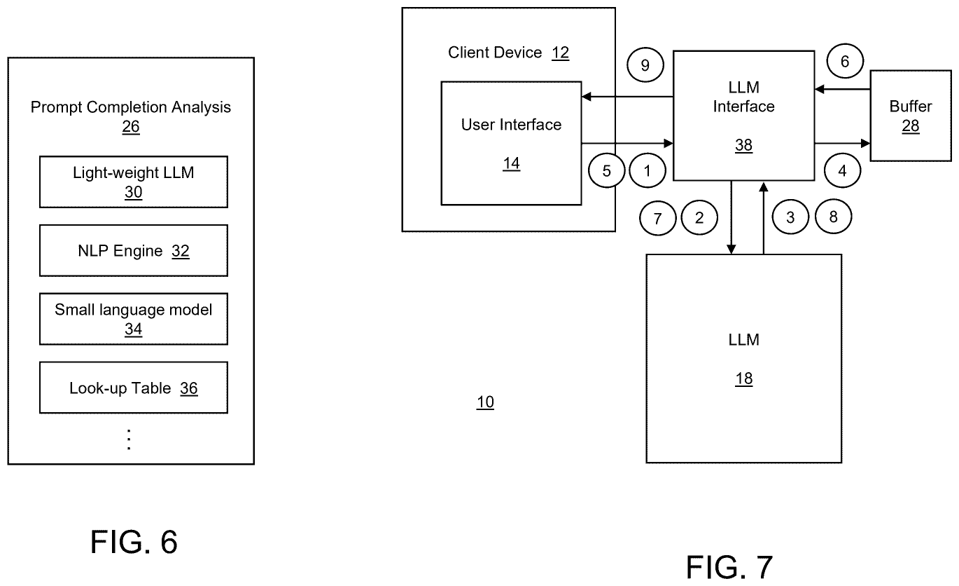

The prompt completion analysis 26 may be embodied as a module, script, function, service, tool, or other software component and may utilize one or more evaluation mechanisms. Referring to FIG. 6, an example of a configuration for a module used to perform a prompt completion analysis 26 is shown. In this example, the prompt completion analysis 26 may include any one or more of the sub-modules shown, without limitation, for example, a light weight LLM 30, an NLP engine 32, a small language model 34, a look-up table 36, etc. It can be appreciated that the evaluation mechanisms may be off-the-shelf or otherwise provided by a third party or may be proprietary or otherwise custom built.

The light weight LLM 30 may be a less “complex” LLM than the primary LLM 18 that is being used by the UI 14 to provide a chatbot. In the present examples, less complex may refer to the light weight LLM 30 being trained on fewer parameters than the primary LLM 18 but trained on a higher number of parameters than, for example, the small language model 34. Other factors that may contribute to the relative complexity of the LLMs or other models that may be utilized in the computing environment 10, may include how long the model has been trained, how many parameters the model has been trained on, the relative disk size, the amount of compute used, etc. That is, any number and complexity of detection mechanisms may be incorporated into multiple different layers of the prompt evaluation and buffering system described herein to buffer and coordinate efficient usage of the primary LLM 18.

The NLP engine 32 may include one or more NLP-based tools or functions that are capable of parsing the text in a user message 20 to determine if the message 20 is incomplete or complete. The NLP engine 32 may have its own model or may access third party models. The small language model 34 may refer to a model that utilizes architectures like transformer, long short-term memory (LSTM) or recurrent neural networks (RNNs) but with a significantly reduced number of parameters compared to LLMs. The small language model 34 may therefore be trained on the narrower task of evaluating messages for completeness.

The look-up-table 36 may provide a database of previous incomplete messages or other searchable text (or voice) fragments or elements that provides another light-weight tool to evaluate the user messages 20 for completeness.

In another implementation, the prompt evaluation and buffering operations described herein may be performed by training the LLM 18 itself, e.g., as shown in FIG. 7. In this implementation, the prompt evaluation module 16 and prompt completion analysis 26 are provided by the LLM 18, by training the LLM 18 to return a “waiting” or “incomplete” token in response to an incomplete prompt. The client device 12 may utilize an LLM interface 38 (e.g., an API) to intercept and handle inputs prior to prompting the LLM 18. The LLM interface 38 in this example may also utilize a buffer 28 as described herein.

At step 1, a user message 20 may be sent by the UI 14 to the LLM interface 38. The LLM interface 38 provides the user message 20 to the LLM 18 at step 2, which processes the user message 20 and generates an LLM response 24 at step 3, which indicates that the input was incomplete. In this example, since the user message 20 was determined by the LLM 18 to be incomplete, that user message 20 may be held by the buffer 28 at step 4. The LLM interface 38 then receives an additional user message 20 at step 5. The additional user message 20 is combined with the buffered input at step 6 and the combined input is used to prompt the LLM 18 again at step 7. The LLM 18 in this case determines that the input is complete and returns an LLM response 24 that is responsive to the complete input at step 8. The LLM interface 38 enables the LLM response 24 to be presented by the UI 14 at step 9. It can be appreciated that the buffering illustrated in FIG. 7 at steps 4 and 6 may represent accessing a chat history to determine the previous incomplete information that is to be combined with the newly received information.

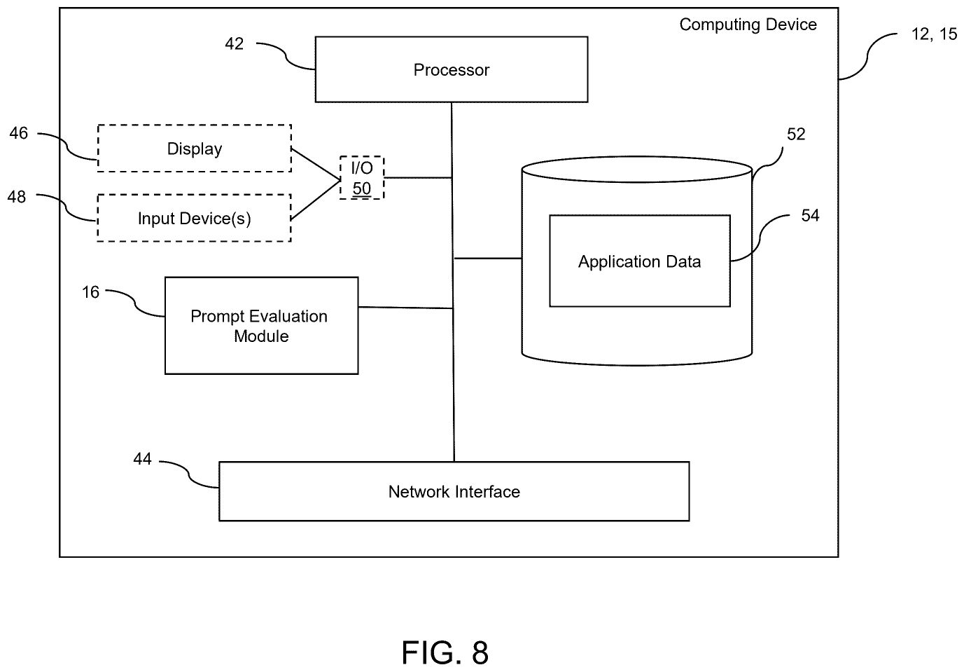

FIG. 8 shows an example of a computing device (e.g., a client device 12 or server device 15) which may be utilized by any one or more of the entities shown in FIGS. 1-7, for example, a personal electronic device or server used to provide the UI 14 that communicates with the LLM 18 via the prompt evaluation module 16. The computing device 12, 15 in FIG. 8 may, additionally or alternatively, provide an example of a device on which the LLM 18 may be deployed or accessed.

In this example, the computing device 12, 15 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 12, 15 may also include the prompt evaluation module 16, a data store 52, and application data 54. Although not shown in FIG. 8, when configured as a client device 12, the computing device or computing system may additionally include a client application that provides the UI 14. Similarly, when configured as a server device 15, the computing device or computing system may include a server application. The computing device 12, 15 may, additionally, include or otherwise have access to the buffer 28.

The data store 52 may represent a database or library or other computer-readable medium configured to store data and permit retrieval of data by the computing device 12, 15. The data store 52 may be read-only or may permit modifications to the data. The data store 52 may also store both read-only and write accessible data in the same memory allocation. In this example, the data store 52 stores the application data 54 for an application and/or data for the prompt evaluation module 16 that is configured to be executed by the computing device 12, 15 for a particular role or purpose.

While not delineated in FIG. 8, the computing device 12, 15 includes at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 22 to operate together as described herein. FIG. 8 illustrates examples of modules and applications stored in memory on the computing device 12, 15 and executed by the processor(s) 42.

It can be appreciated that any of the modules and applications shown in FIG. 8 may be hosted externally and may be available to the computing device 12, 15, e.g., via a network interface 44. The data store 52 in this example stores, among other things, the application data 54 that can be accessed and utilized by an application. The data store 52 may additionally store one or more software functions or routines in a cache or in other types of memory.

As shown in FIG. 8, the computing device 22 may, optionally (e.g., when configured as a personal electronic device such as a smartphone or tablet), include a display 46 and one or more input device(s) 48 that may be utilized via an input/output (I/O) module 50. That is, such components may be omitted when the computing device 22 does not interact with a user.

While examples referred to herein may refer to a single display 46 for ease of illustration, the principles discussed herein may also be applied to multiple displays 46, e.g., to view portions of UIs 14 rendered by or with an application on separate side-by-side screens. That is, any reference to a display 46 may include any one or more displays 46 or screens providing similar visual functions. The UI 14 may receive one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the client device 12.

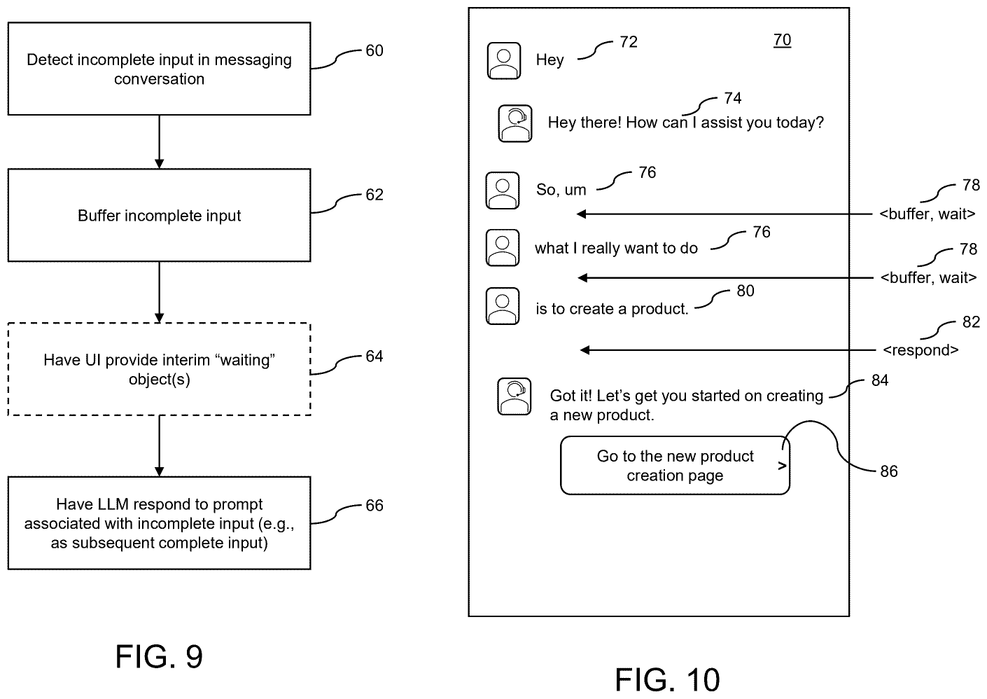

Referring now to FIG. 9, a flow chart is provided illustrating example operations for handling incomplete inputs prior to prompting an LLM 18. The operations shown in FIG. 9 may be implemented by an electronic device (e.g., client device 12), a server (e.g., server device 15), or other computing system, computing service, or other computing entity in the computing environment 10.

At block 60, an incomplete input in a messaging conversation is detected, e.g., as illustrated in any one of the configurations shown in FIGS. 1-7.

At block 62, the incomplete input is buffered, e.g., by the prompt evaluation module 16 using the buffer 28. Optionally, at block 64, an interim waiting indicator 21 may be provided to the UI 14 such that a waiting object may be presented to the user.

At block 66, the prompt evaluation module 16 may have the LLM 18 respond to a prompt associated with the incomplete input, e.g., by buffering the incomplete input prior to doing so, as in block 62, and combining the incomplete input with additional information such as an additional message.

Referring now to FIG. 10, a messaging conversation UI page 70 is shown, e.g., for conducting a conversation with a chatbot that utilizes the LLM 18 to assist with queries, questions, or other requests. The UI page 70 presents messages exchanged between parties. In this example, a first message 72 composed by the user includes the opening: “Hey”. The chatbot replies with an introductory message: “Hey there! How can I assist you today?”. The user may then reply, in this example with a first portion 76 of a response: “So, um”. Utilizing the prompt evaluation module 16 as illustrated above, the client device 12 or server device 15 determines that “So, um” is an incomplete input. Rather than have the LLM 18 generate a response to “So, um”, the system buffers and waits 78, allowing for a second portion 76 of the response: “what I really want to do”.

As shown in FIG. 10, the prompt evaluation module 16 determines that, even when combined (i.e., “So, um what I really want to do”), the first and second portions 76 of the input are incomplete and the system again buffers and waits 78. The user then follows up with a third portion 80 of the input: “is to create a product”, which is determined by the prompt evaluation module 16 to complete the input, and the system responds 82 with the message: “Got it! Let's get you started on creating a new product”. In this example, the chatbot may provide additional content such as the linked content 86 for a new product creation page.

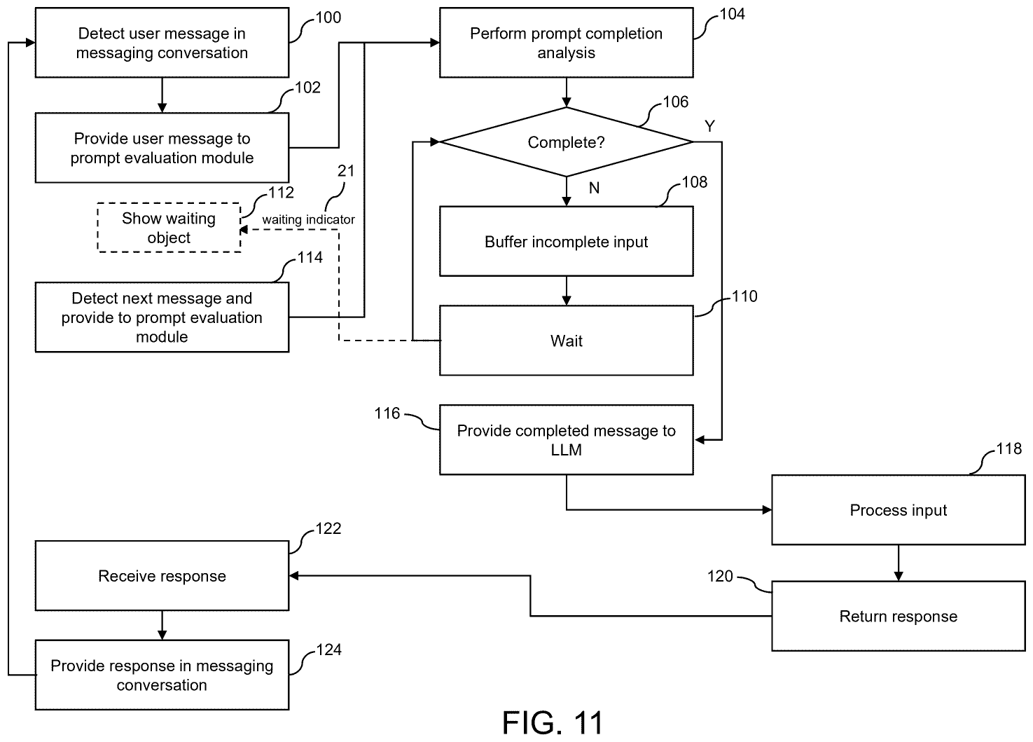

Referring now to FIGS. 11-14, operations that may be performed in evaluating user inputs are shown, e.g., as illustrated in FIG. 10.

FIG. 11 illustrates operations that may be performed by the client side and the server side to evaluate and buffer incomplete inputs prior to prompting the LLM 18 using the configuration shown in FIG. 2.

At block 100, a user message 20 is detected in a messaging conversation (e.g., portion 76 as shown in FIG. 10). At block 102, the user message 20 is provided to the prompt evaluation module 16, in this example configuration, on the server side. At block 104, a prompt completion analysis 26 is performed to determine at block 106 whether the user message 20 constitutes a complete input. If not, the incomplete input is buffered at block 108 and the prompt evaluation module 16 waits at block 110. Optionally, a waiting indicator 21 may be sent back to the client side to have a waiting object presented at block 112.

At block 114, a next user message 20 is detected in the messaging conversation and the next user message 20 is provided to the prompt evaluation module 16. In this example, it is assumed that the next user message 20 provides the additional information required to generate a completed message 22 to be provided to the LLM 18 at block 116.

The LLM 18 may then process the completed message 22 at block 118 and return an LLM response 24 at block 120. The response 24 is received at the client side at block 122 and the response 24 may be presented in the messaging conversation (e.g., in the UI 14) at block 124.

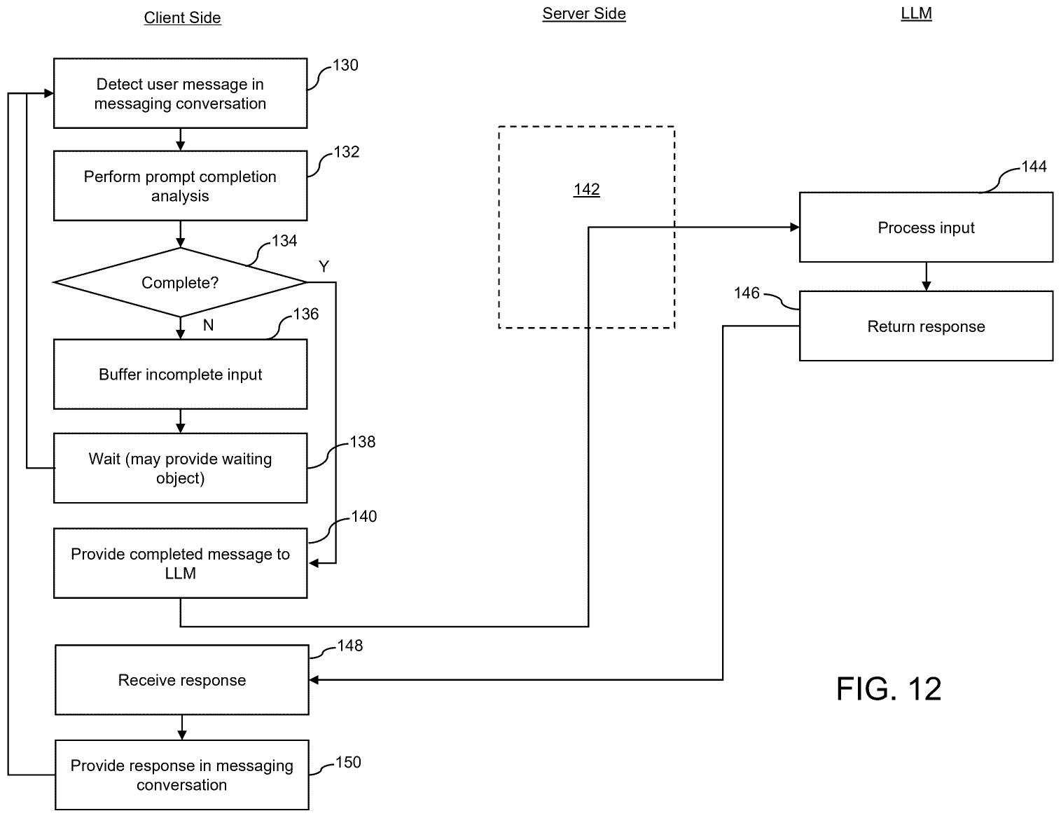

FIG. 12 illustrates operations that may be performed by the client side and the server side to evaluate and buffer incomplete inputs prior to prompting the LLM 18 using the configuration shown in FIG. 3.

At block 130, a user message 20 is detected in a messaging conversation (e.g., portion 76 as shown in FIG. 10). The user message 20 is provided to the prompt evaluation module 16, in this example configuration, on the client side. At block 132, a prompt completion analysis 26 is performed to determine at block 134 whether the user message 20 constitutes a complete input. If not, the incomplete input is buffered at block 136 and the prompt evaluation module 16 waits at block 138. Optionally, a waiting indicator 21 may be generated on the client side to have a waiting object presented.

A next user message 20 is detected in the messaging conversation and the next user message 20 is provided to the prompt evaluation module 16. In this example, it is assumed that the next user message 20 provides the additional information required to generate a completed message 22 to be provided to the LLM 18 at block 140. As illustrated in FIG. 12, the complete input may be sent to a server side interface 142 such as an API. For example, the server side interface 142 may process the complete input to generate an LLM prompt in a particular format and/or using particular syntax as required.

The LLM 18 may then process the completed message 22 at block 144 and return an LLM response 24 at block 146. The response 24 is received at the client side at block 148 and the response 24 may be presented in the messaging conversation (e.g., in the UI 14) at block 150.

It can be appreciated that when utilizing the configuration shown in FIG. 4, the client device 12 and server device 15 may be configured to perform the operations as illustrated in both FIGS. 11 and 12.

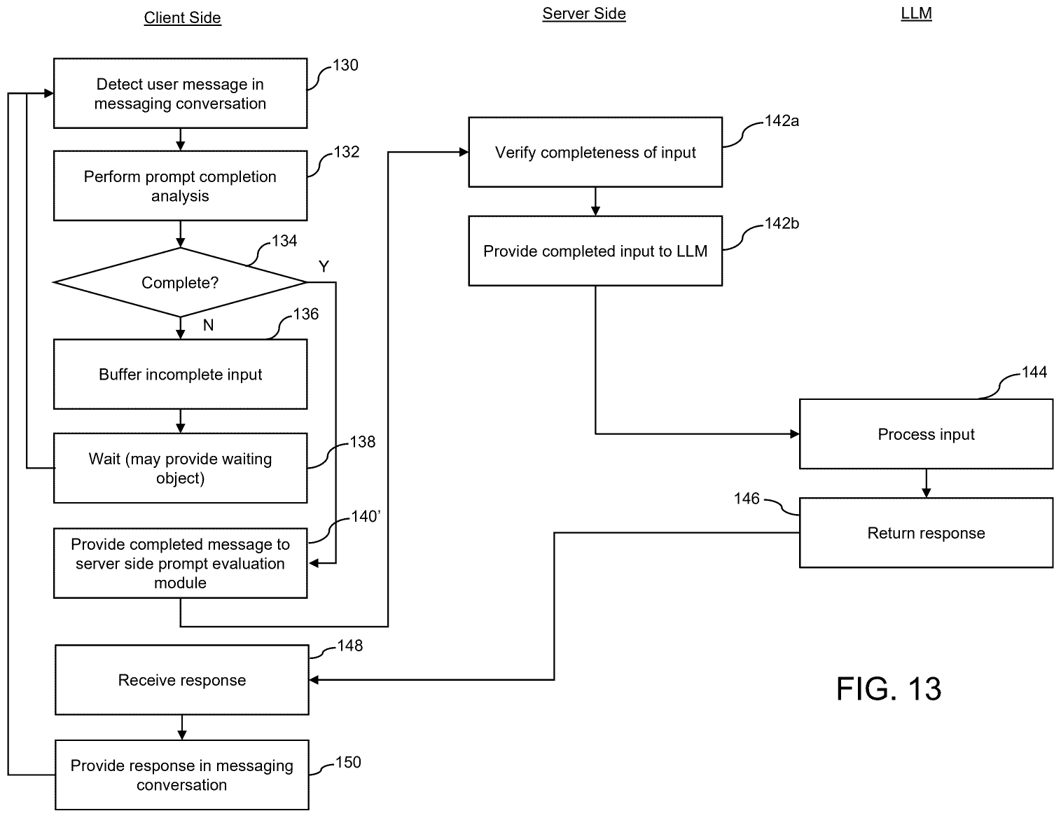

FIG. 13 illustrates operations that may be performed by the client side and the server side to evaluate and buffer incomplete inputs prior to prompting the LLM 18 using the configuration shown in FIG. 5. Blocks 130 through 138 may be implemented in a manner similar to those in FIG. 12 and described above and thus need not be reiterated. At block 140′, the completed message 22 determined at the client side may be provided to a prompt evaluation module 16 at the server side (e.g., as illustrated in FIG. 5) to have the server side verify the completeness of the input at block 142a. In this example it may be assumed that the input is verified as being complete and the completed message 22 may be provided to the LLM at block 142b. In this way, the client and server side may work together to evaluate the completeness of the user message 20 using tools available at each side. For example, a lighter weight tool may be used by the client side with the server side verifying the output of the lighter weight tool as a safety net. Blocks 144 through 150 may be performed in a manner similar to those shown in FIG. 12 and details need not be reiterated.

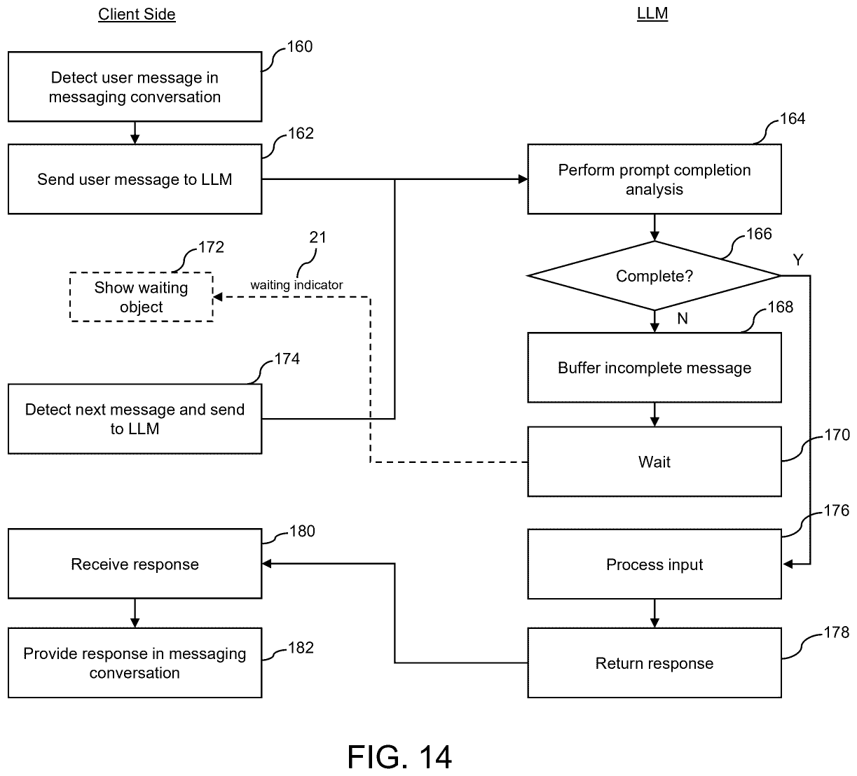

FIG. 14 illustrates operations that may be performed in utilizing an LLM 18 trained to evaluate inputs for completeness, e.g., using the configuration shown in FIG. 7.

At block 160, a user message 20 is detected in a messaging conversation (e.g., portion 76 as shown in FIG. 10). At block 162, the user message 20 is provided to the LLM 18, either directly by the client device 12 or via a server side interface as described herein by way of example. At block 164, a prompt completion analysis 26 is performed by the LLM 18 to determine at block 166 whether the user message 20 constitutes a complete input. If not, the incomplete input is buffered at the server side or otherwise by a computing entity hosting or coupled to the LLM 18 at block 168 and waits at block 170. Optionally, a waiting indicator 21 may be sent back to the client side to have a waiting object presented at block 172.

At block 174, a next user message 20 is detected in the messaging conversation and the next user message 20 is provided to the LLM 18 to perform another prompt completion analysis. In this example, it is assumed that the next user message 20 provides the additional information required to generate a completed message 22 to be processed by the LLM 18 at block 176.

The LLM 18 may then return an LLM response 24 at block 178. The response 24 is received at the client side at block 180 and the response 24 may be presented in the messaging conversation (e.g., in the UI 14) at block 182.

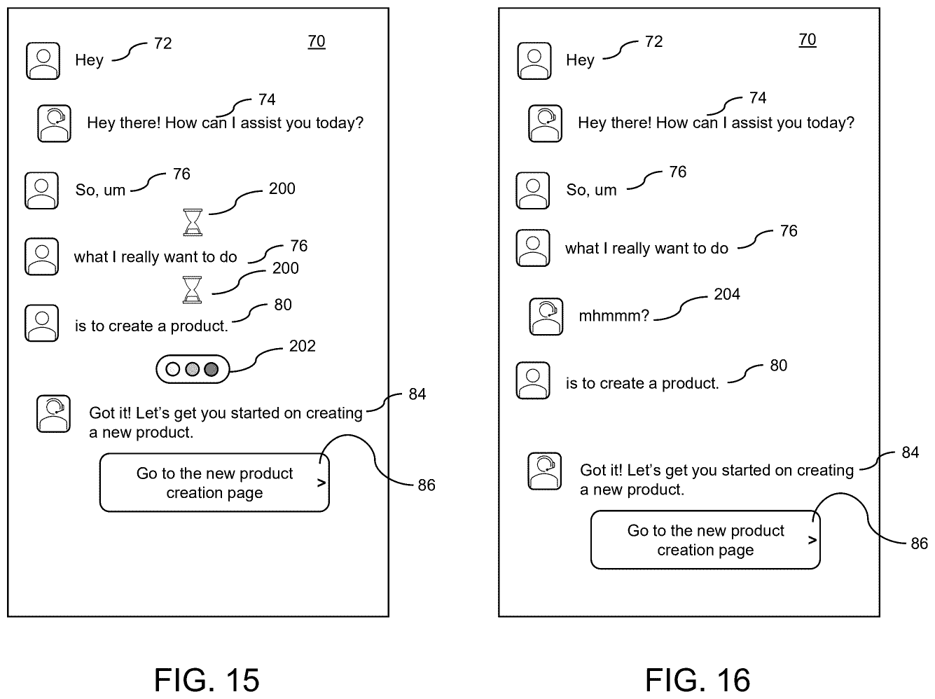

FIGS. 15 through 18 illustrate variations in the messaging conversation UI page 70 shown in FIG. 10 to show example options for providing waiting objects in response to receipt of a waiting indicator 21. Referring first to FIG. 15, an hourglass object 200 may be displayed after a deemed incomplete message 76 to indicate that the system is waiting for additional input. In this example, after the portion 80 is entered, which completes the input, a pending reply animation 202 may be displayed to indicate that the chatbot (i.e. the LLM 18) is now processing the completed message 22.

FIG. 16 illustrates a waiting message 204, in this example: “mhmmm?”, which is used to signal to the user that the chatbot is waiting for a further input, such as the additional portion 80, which is used to generate the completed message 22.

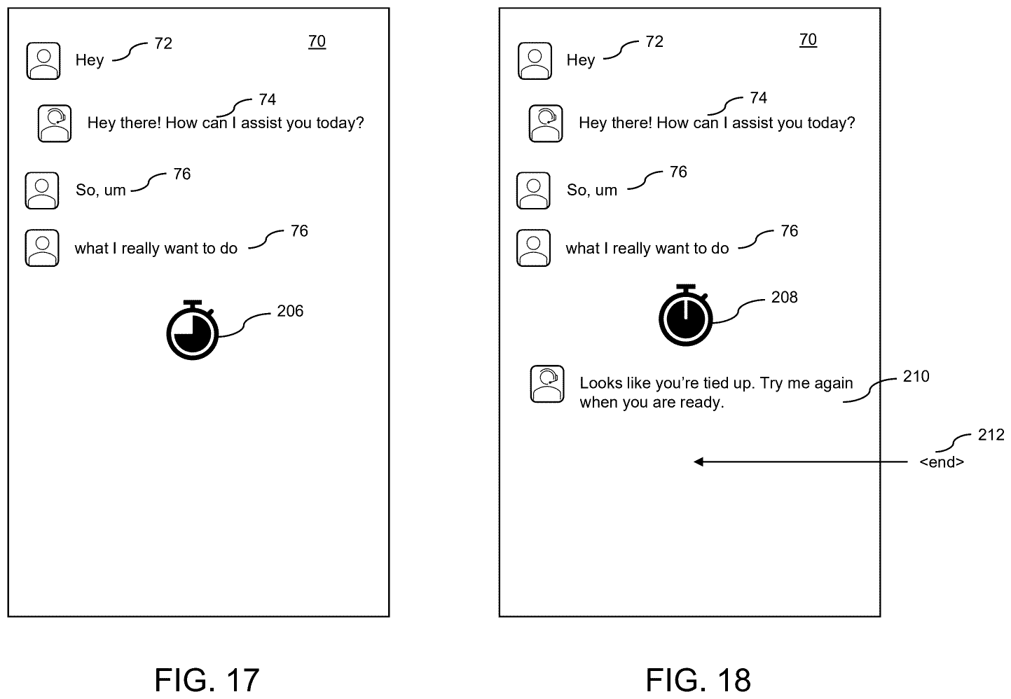

Since incomplete inputs may, in some circumstances, occur due to inactivity by the user (e.g., distraction, emergency or otherwise leaving the chat), a timer object 206 may be displayed as shown in FIG. 17. The timer object 206 may be displayed subsequent to a waiting object to indicate that the chatbot is now triggering a time limit on a further input or may be used as the waiting object. As illustrated in FIG. 18, the timer object 206 may be replaced with an elapsed timer object 208 when the time has expired on receiving a further input. A follow-up message 210 may be displayed, e.g.: “Looks like you're tied up. Try me again when you are ready.”. This follow-up message 210 may be used to notify the user that the session with the LLM 18 is being terminated at 212. In this way, the chatbot/LLM 18 is not left hanging indefinitely when a further input is deemed to be unlikely.

With respect to the LLM 18, examples of generative models that may be used include, for example, OpenAI's Generative Pre-trained Transformer family (GPT 3.5, GPT 4, ChatGPT), Meta's Llama and Llama 2, CohereAI's Command, Mistral/Mixtral, Anthropic's Claude, Google's Gemini, Gemma and Bard. These general purpose and chat-focused models may be used as both the first and second model. It can be appreciated that, in addition, more specialized models may be used as the first or second model. For example, if the error in the first model is related to code generation then a generative model specializing in code generation may be used as the second model—the Code Llama, HuggingFace's CodeGen, Github Copilot's Codex model or similar may be used. In some cases, instead of text generation models, multimodal or multimedia models may be used such as BLIP-2, CLIP, or GPT-4V. These may be used to analyze user interfaces or user interface elements, or generate user interfaces or user interface elements.

It can be appreciated that although transformer-based language models are described herein, the present disclosure may be applicable to any ML-based language model, including language models based on other neural network architectures such as RNN-based language models. Indeed, the consideration of an LLM 18 above is by way of example and the present disclosure and principles are not necessarily so limited. For example, the techniques described above may be applied to other generative models such as, for example, other text generation models or multimedia models such as may serve to generate other forms of output or accept other forms of input beyond text (and which may, in some implementations, potentially include a generative text model along with one or more other models). In a specific example, a generative model (e.g., a multimedia model) that includes, amongst other types of models, an LLM 18 in it, may be employed in association with the above-discussed techniques.

### Neural Networks and Machine Learning

To assist in understanding the present disclosure, some concepts relevant to neural networks and machine learning (ML) are discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), RNNs, and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

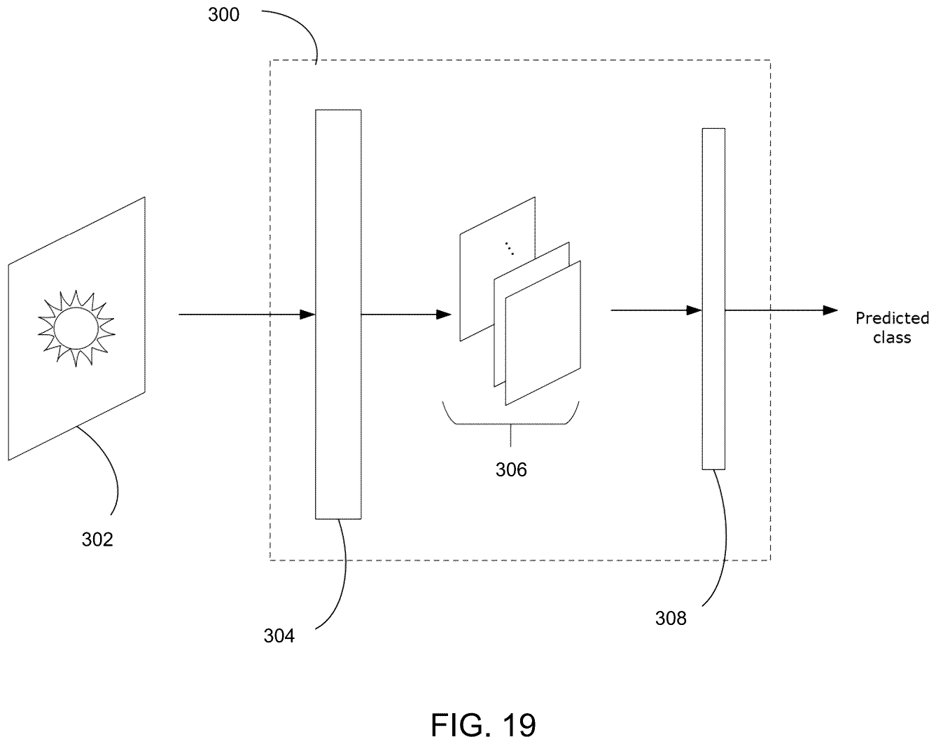

FIG. 19 is a simplified diagram of an example CNN 300, which is an example of a DNN that is commonly used for image processing tasks such as image classification, image analysis, object segmentation, etc. An input to the CNN 300 may be a 2D RGB image 302.

The CNN 300 includes a plurality of layers that process the image 302 in order to generate an output, such as a predicted classification or predicted label for the image 302. For simplicity, only a few layers of the CNN 300 are illustrated including at least one convolutional layer 304. The convolutional layer 304 performs convolution processing, which may involve computing a dot product between the input to the convolutional layer 304 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 304 is a set of feature maps 306 (sometimes referred to as activation maps). Each feature map 306 generally has smaller width and height than the image 302. The set of feature maps 306 encode image features that may be processed by subsequent layers of the CNN 300, depending on the design and intended task for the CNN 300. In this example, a fully connected layer 308 processes the set of feature maps 306 in order to perform a classification of the image, based on the features encoded in the set of feature maps 306. The fully connected layer 308 contains learned parameters that, when applied to the set of feature maps 306, outputs a set of probabilities representing the likelihood that the image 302 belongs to each of a defined set of possible classes. The class having the highest probability may then be outputted as the predicted classification for the image 302.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs 18.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of an LLM 18 may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

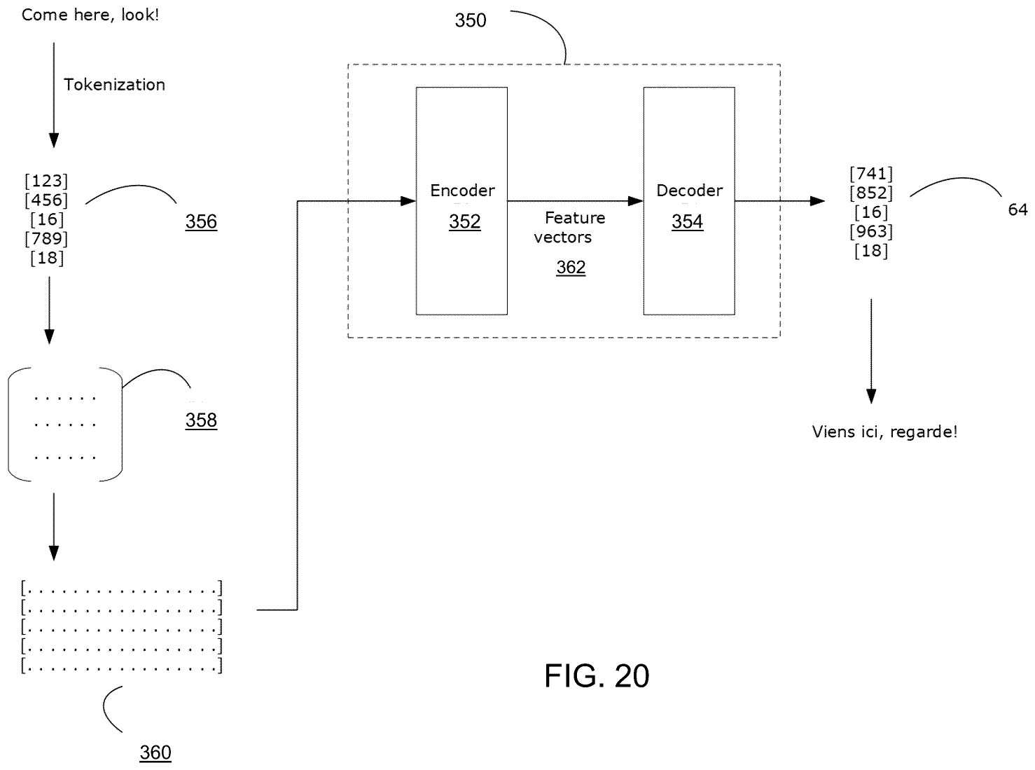

FIG. 20 is a simplified diagram of an example transformer 350, and a simplified discussion of its operation is now provided. The transformer 350 includes an encoder 352 (which may comprise one or more encoder layers/blocks connected in series) and a decoder 354 (which may comprise one or more decoder layers/blocks connected in series). Generally, the encoder 352 and the decoder 354 each include a plurality of neural network layers, at least one of which may be a self-attention layer. The parameters of the neural network layers may be referred to as the parameters of the language model.

The transformer 350 may be trained on a text corpus that is labelled (e.g., annotated to indicate verbs, nouns, etc.) or unlabelled. LLMs 18 may be trained on a large unlabelled corpus. Some LLMs 18 may be trained on a large multi-language, multi-domain corpus, to enable the model to be versatile at a variety of language-based tasks such as generative tasks (e.g., generating human-like natural language responses to natural language input).

An example of how the transformer 350 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 20, a short sequence of tokens 356 corresponding to the text sequence “Come here, look!” is illustrated as input to the transformer 350. Tokenization of the text sequence into the tokens 356 may be performed by some preprocessing tokenization module such as, for example, a byte pair encoding tokenizer (the “pre” referring to the tokenization occurring prior to the processing of the tokenized input by the LLM 18), which is not shown in FIG. 20 for simplicity. In general, the token sequence that is inputted to the transformer 350 may be of any length up to a maximum length defined based on the dimensions of the transformer 350 (e.g., such a limit may be 2048 tokens in some LLMs 18). Each token 356 in the token sequence is converted into an embedding vector 360 (also referred to simply as an embedding). An embedding 360 is a learned numerical representation (such as, for example, a vector) of a token that captures some semantic meaning of the text segment represented by the token 356. The embedding 360 represents the text segment corresponding to the token 356 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 360 corresponding to the “look” token will be closer to another embedding corresponding to the “see” token in the vector space, as compared to the distance between the embedding 360 corresponding to the “look” token and another embedding corresponding to the “cake” token. The vector space may be defined by the dimensions and values of the embedding vectors. Various techniques may be used to convert a token 356 to an embedding 360. For example, another trained ML model may be used to convert the token 356 into an embedding 360. In particular, another trained ML model may be used to convert the token 356 into an embedding 360 in a way that encodes additional information into the embedding 360 (e.g., a trained ML model may encode positional information about the position of the token 356 in the text sequence into the embedding 360). In some examples, the numerical value of the token 356 may be used to look up the corresponding embedding in an embedding matrix 358 (which may be learned during training of the transformer 350).

The generated embeddings 360 are input into the encoder 352. The encoder 352 serves to encode the embeddings 360 into feature vectors 362 that represent the latent features of the embeddings 360. The encoder 352 may encode positional information (i.e., information about the sequence of the input) in the feature vectors 362. The feature vectors 362 may have very high dimensionality (e.g., on the order of thousands or tens of thousands), with each element in a feature vector 362 corresponding to a respective feature. The numerical weight of each element in a feature vector 362 represents the importance of the corresponding feature. The space of all possible feature vectors 362 that can be generated by the encoder 352 may be referred to as the latent space or feature space.

Conceptually, the decoder 354 is designed to map the features represented by the feature vectors 362 into meaningful output, which may depend on the task that was assigned to the transformer 350. For example, if the transformer 350 is used for a translation task, the decoder 354 may map the feature vectors 362 into text output in a target language different from the language of the original tokens 356. Generally, in a generative language model, the decoder 354 serves to decode the feature vectors 362 into a sequence of tokens. The decoder 354 may generate output tokens 364 one by one. Each output token 364 may be fed back as input to the decoder 354 in order to generate the next output token 364. By feeding back the generated output and applying self-attention, the decoder 354 is able to generate a sequence of output tokens 364 that has sequential meaning (e.g., the resulting output text sequence is understandable as a sentence and obeys grammatical rules). The decoder 354 may generate output tokens 364 until a special [EOT] token (indicating the end of the text) is generated. The resulting sequence of output tokens 364 may then be converted to a text sequence in post-processing. For example, each output token 364 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs 18. An example GPT-type LLM 18 is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM 18, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an API). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM 18 may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM 18 may be referred to as a prompt, which is a natural language input that includes instructions to the LLM 18 to generate a desired output. A computing system may generate a prompt that is provided as input to the LLM 18 via its API. As described above, the prompt may optionally be processed or preprocessed into a token sequence prior to being provided as input to the LLM 18 via its API. A prompt can include one or more examples of the desired output, which provides the LLM 18 with additional information to enable the LLM 18 to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any entity within the computing environment 10 such as the computing devices 12, 15; any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method comprising:
responsive to detecting an incomplete input in a messaging conversation, buffering the incomplete input prior to having a large language model (LLM) respond to a prompt associated with the incomplete input.

2. The method of claim 1, wherein the incomplete input is detected at a client device.

3. The method of claim 2, wherein the incomplete input is buffered at the client device.

4. The method of claim 1, wherein the incomplete input is detected using a natural language processing (NLP) tool applied to the incomplete input.

5. The method of claim 1, wherein the incomplete input is detected using another LLM applied to the incomplete input.

6. The method of claim 1, wherein the incomplete input is detected using a small language model.

7. The method of claim 2, further comprising:
receiving the incomplete input as detected at the client device; and
confirming that the input is incomplete at a server device prior to the buffering.

8. The method of claim 7, wherein the confirming is performed using another LLM.

9. The method of claim 1, wherein the incomplete input is detected at a server device, the server device being in communication with the LLM.

10. The method of claim 9, wherein the incomplete input is buffered at the server device.

11. The method of claim 1, wherein the incomplete input is buffered at either a client device or a server device.

12. The method of claim 1, wherein the incomplete input is detected by the LLM, the buffering comprising receiving additional information prior to sending a response to a client device.

13. The method of claim 1, wherein the buffering comprises retrieving the incomplete input from a conversation history.

14. The method of claim 1, wherein the buffering comprises receiving at least one additional input.

15. The method of claim 14, wherein a user interface (UI) associated with the messaging conversation displays at least two consecutive messages from an entity providing the incomplete input prior to a response message based on the prompt.

16. The method of claim 1, further comprising having an interim object displayed in the messaging conversation during the buffering.

17. The method of claim 16, wherein the interim object comprises a message indicative of a pause or silence in a conversation following a message comprising the incomplete input.

18. The method of claim 16, wherein the interim object comprises an animation or icon indicative of the buffering.

19. The method of claim 1, wherein the incomplete input comprises a voice message.

20. The method of claim 1, wherein the incomplete input comprises text composed in a message.

21. The method of claim 1, further comprising executing an action in the messaging conversation responsive to detecting expiration of a timer.

22. The method of claim 21, wherein the action comprises providing a response message in the messaging conversation.

23. The method of claim 21, wherein the action comprises terminating the messaging conversation.

24. The method of claim 1, wherein the buffering comprises accumulating at least one additional incomplete input.

25. A computer system comprising:
at least one processor; and
at least one memory, the at least one memory comprising processor executable instructions that, when executed by the at least one processor, cause the computer system to:
responsive to detecting an incomplete input in a messaging conversation, buffer the incomplete input prior to having a large language model (LLM) respond to a prompt associated with the incomplete input.

26. A computer-readable medium comprising processor executable instructions that, when executed by a processor of a computer system, cause the computer system to:
responsive to detecting an incomplete input in a messaging conversation, buffer the incomplete input prior to having a large language model (LLM) respond to a prompt associated with the incomplete input.
